(19) United States
(12) Patent Application Publication
(10) Pub. No.: US 2011/0300274 A1
(43) Pub. Date: Dec. 8, 2011

(54) Wild bird feed and method of making same

(76) Inventor: Raymon W. Lush, Bloomfield, NE (US)

(21) Appl. No.: 12/802,344

(22) Filed: Jun. 4, 2010

(51) Int. Cl. A23K 1/18; A23K 1/20; A23P 1/12; A23K 1/14; A23L 3/34

(52) U.S. Cl. 426/321; 426/623

(57) ABSTRACT

A wild bird feed is disclosed which is comprised of ground dry mature sweet corn, water and wild bird feed.

### BACKGROUND OF THE INVENTION

1. Field of the Invention

This invention relates to wild bird feed and the method of making the same, and more particularly to wild bird feed which is cold extruded to form blocks or logs which are weather resistant. Even more particularly, the wild bird feed of this invention is comprised of dry ground mature sweet corn, water and wild bird feed.

2. Description of the Related Art

Wild birds are fed in many different ways. The wild bird feed may be placed in feeders such as disclosed in Applicant's U.S. Pat. Nos. 6,047,661; 6,073,582; 6,427,629; 6,866,004; 7,032,538; 7,131,395; 7,185,605; 7,198,004; 7,237,508; 7,302,911; 7,503,282; and 7,506,611. The wild bird feed may also be formed into suet blocks, etc. Regardless of whether the bird feed is placed in the bird feeders or whether the bird feed is in a suet block, the bird feed is subjected to rain and snow. In other words, the prior art methods of feeding wild birds do not involve a product which is weather resistant.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

A cold extruded wild bird feed block or log is disclosed which is comprised of ground dry mature sweet corn, water and wild bird feed. In the preferred embodiment, the ground dry mature sweet corn comprises 25 to 35 percent of the mixture with the water comprising five to 15 percent of the mixture and the wild bird feed comprising the rest of the mixture. In the preferred embodiment, the wild bird feed is selected from the group of wheat, oats, barley, maize, brown rice, rye, amaranth, popcorn, speet, emmer, millet, dehulled oat groats, sorghum, buckwheat, bulgur, quinoa, triticale, faro, kamut, teff, black oil, sunflower seed, striped sunflower seed, safflower seed, niger thistle seed, canary grass seed, flax seed, nuts such as peanuts, almonds, filberts, walnuts, pecans, dried fruit, beans and peas.

The resultant cold extruded block or log is weather resistant so that it remains substantially intact until it has been completely consumed by the birds. The method of making the wild bird feed is also described.

It is a principal object of the invention to provide a wild bird feed block or log which is comprised of ground dry mature sweet corn, water and wild bird feed.

A further object of the invention is to provide a cold extruded wild bird feed block or log which is comprised of ground dry mature sweet corn, water and wild bird feed.

A further object of the invention is to provide a cold extruded wild bird feed block or log which is weather resistant.

A further object of the invention is to provide a wild bird feed block or log which may also have a preservative added thereto.

These and other objects will be apparent to those skilled in the art.

### DESCRIPTION OF THE PREFERRED EMBODIMENT

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

Ground dry mature sweet corn is mixed with water and wild bird feed. The mixture is then cold extruded to form a wild bird feed block or log. One type of cold extrusion machine which may be used is that manufactured by California Pellet Mill Company.

In the preferred embodiment, the dry mature sweet corn comprises 25 to 35 percent of the mixture with the water comprising five to 15 percent of the mixture and the wild bird feed comprising the remainder of the block or log. The wild bird feed is selected from the group of wheat, oats, barley, maize, brown rice, rye, amaranth, popcorn, speet, emmer, millet, dehulled oat groats, sorghum, buckwheat, bulgur, quinoa, triticale, faro, kamut, teff, black oil, sunflower seed, striped sunflower seed, safflower seed, niger thistle seed, canary grass seed, flax seed, nuts such as peanuts, almonds, filberts, walnuts, pecans, dried fruit, beans and peas.

The resulting product is weather resistant and remains substantially intact until the wild birds have consumed the same. Example No. 1, listed below, provides a product which is 60 percent wild bird feed, 25 percent water and 15 percent ground dry mature sweet corn.

### EXAMPLE NO. 1 (60-25-15)

| | |
|---|---|
| 1200 lbs | Wild bird feed |
| 500 lbs | Ground dry mature sweet corn |
| 300 lbs | Water |
| 2000 lb | Batch |

In Example No. 2 below, the mixture is comprised of 60 percent wild bird feed, 30 percent dry ground mature sweet corn and 10 percent water.

### EXAMPLE NO. 2 (60-30-10)

| | |
|---|---|
| 1200 lbs | Wild bird feed |
| 600 lbs | Ground dry mature sweet corn |
| 300 lbs | Water |
| 2000 lb | Batch |

In Example No. 3, the wild bird feed comprises 60 percent of the mixture with the dry ground mature sweet corn comprising 35 percent of the mixture and the water comprising five percent of the mixture.

### EXAMPLE NO. 3 (60-35-5)

| | |
|---|---|
| 1200 lbs | Wild bird feed |
| 700 lbs | Ground dry mature sweet corn |
| 100 lbs | Water |
| 2000 lb | Batch |

Example No. 4 below is a typical formulation for one form of the wild bird feed of this invention.

### EXAMPLE NO. 4

| | | |
|---|---|---|
| 800 | lb | Ground dry mature sweet corn |
| 500 | lb | Millet |
| 400 | lb | Sunflower hearts |
| 100 | lb | Oat groats |
| 100 | lb | Whole wheat |
| 50 | lb | Black oil sunflower seeds |
| 50 | lb | Barley |
| 50 | lb | Safflower |
| 50 | lb | Flax |
| 30 | lb | Calcium propionate |
| 20 | lb | Salt |
| 15 | lb | Citric acid |
| 335 | lb | Water |
| 2500 | lb | Batch |

Thus it can be seen that the invention accomplishes at least all of its stated objectives.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

1. A method of feeding wild birds comprising the steps of:
providing a predetermined quantity of ground dry mature sweet corn;
providing a predetermined quantity of water;
providing a predetermined quantity of wild bird feed;
mixing the sweet corn, water and wild bird feed;
cold extruding the mixture under pressure to produce weather resistant blocks, or logs;
and feeding the blocks or logs to wild birds;

2. The method of claim 1 wherein the sweet corn comprises about 25 to 35 percent of the mixture.

3. The method of claim 1 wherein the water comprises about five to 15 percent of the mixture.

4. The method of claim 1 wherein the wild bird feed is selected from the group of wheat, oats, barley, maize, brown rice, rye, amaranth, popcorn, speet, emmer, millet, dehulled oat groats, sorghum, buckwheat, bulgur, quinoa, triticale, faro, kamut, teff, black oil, sunflower seed, striped sunflower seed, safflower seed, niger thistle seed, canary grass seed, flax seed, nuts such as peanuts, almonds, filberts, walnuts, pecans, dried fruit, beans and peas.

5. The method of claim 1 wherein a predetermined quantity of a preservative is added to the mixture.

6. The method of preparing wild bird feed, comprising the steps of:
providing ground dry mature sweet corn;
providing water;
providing wild bird feed;
mixing the sweet corn, water with the wild bird feed; and
cold extruding the mixture to produce weather resistant blocks, logs or the like.

7. The method of claim 6 wherein the sweet corn comprises about 25 to 35 percent of the mixture.

8. The method of claim 7 wherein the water comprises about five to 15 percent of the mixture.

9. The method of claim 5 wherein the wild bird feed is selected from the group of wheat, oats, barley, maize, brown rice, rye, amaranth, popcorn, speet, emmer, millet, dehulled oat groats, sorghum, buckwheat, bulgur, quinoa, triticale, faro, kamut, teff, black oil, sunflower seed, striped sunflower seed, safflower seed, niger thistle seed, canary grass seed, flax seed, nuts such as peanuts, almonds, filberts, walnuts, pecans, dried fruit, beans and peas.

10. A cold extruded wild bird feed block or log comprising ground dry mature sweet corn, water and wild bird feed.

11. The cold extruded wild bird feed block or log of claim 10 wherein the wild bird feed is selected from the group of wheat, oats, barley, maize, brown rice, rye, amaranth, popcorn, speet, emmer, millet, dehulled oat groats, sorghum, buckwheat, bulgur, quinoa, triticale, faro, kamut, teff, black oil, sunflower seed, striped sunflower seed, safflower seed, niger thistle seed, canary grass seed, flax seed, nuts such as peanuts, almonds, filberts, walnuts, pecans, dried fruit, beans and peas.

12. The cold extruded wild bird feed block or log of claim 10 wherein the sweet corn comprises about 25 to 35 percent of the mixture.

13. The cold extruded wild bird feed block or log of claim 10 wherein the water comprises about five to 15 percent of the mixture.
